(19) United States
(12) Patent Application Publication
(10) Pub. No.: US 2021/0298305 A1
(43) Pub. Date: Sep. 30, 2021

(54) USE OF A DIFLUORO-(2-HYDROXYPROPYL)PYRIDINE COMPOUND AS A FUNGICIDE FOR CONTROL OF PHYTOPATHOGENIC FUNGI OF WHEAT

(71) Applicant: Dow AgroSciences LLC, Indianapolis, IN (US)

(72) Inventors: Brian Husband, New Plymouth (NZ); Courtney Gallup, Indianapolis, IN (US)

(21) Appl. No.: 16/462,836

(22) PCT Filed: Nov. 22, 2017
(86) PCT No.: PCT/US2017/062965

§ 371 Date: May 21, 2019

Related U.S. Application Data
(60) Provisional application No. 62/425,562, filed on Nov. 22, 2016.

(51) Int. Cl. A01N 43/653

(52) U.S. Cl. CPC A01N 43/653

(57) ABSTRACT

The present disclosure is related to the field of agrochemicals, including compound I and its' use to control fungal diseases in wheat.

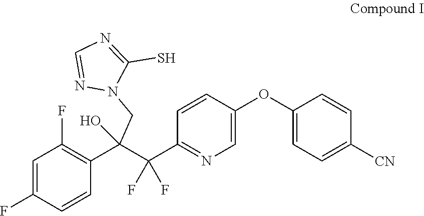 [SMILES: N#Cc1ccc(Oc2ccc(C(F)(F)C(O)(Cn3ncnc3S)c3ccc(F)cc3F)nc2)cc1]

### CROSS-REFERENCE TO RELATED APPLICATION(S)

The present application claims priority under 35 U.S.C. § 119(e) to U.S. provisional patent application, U.S. Ser. No. 62/425,562, filed Nov. 22, 2016, the entire contents of which is incorporated herein by reference.

### FIELD OF THE INVENTION

This present disclosure is related to the field of the use of 4-((6-(2-(2,4-difluorophenyl)-1,1-difluoro-2-hydroxy-3-(5-mercapto-1H-1,2,4-triazol-1-yl)propyl)pyridin-3-yl)oxy)benzonitrile to control fungal diseases of wheat.

### BACKGROUND AND SUMMARY OF THE INVENTION

Fungicides are compounds, of natural or synthetic origin, which act to protect and cure plants against damage caused by agriculturally-relevant fungi. Generally, no single fungicide is useful in all situations. Consequently, research is ongoing to produce fungicides that may have better performance, are easier to use, and cost less.

The present disclosure relates to 4-((6-(2-(2,4-difluorophenyl)-1,1-difluoro-2-hydroxy-3-(5-mercapto-1H-1,2,4-triazol-1-yl)propyl)pyridin-3-yl)oxy)benzonitrile (compound I) and its use as a fungicide. Compound I may offer protection against ascomycetes, basidiomycetes, deuteromycetes and oomycetes.

One embodiment of the present disclosure includes a method of controlling a pathogen-induced disease in a plant that is at risk of being diseased from the pathogen comprising contacting the plant or an area adjacent to the plant with a composition including compound I.

Another embodiment of the present disclosure is a use of compound I for protection of a plant against attack by a phytopathogenic organism or the treatment of a plant infested by a phytopathogenic organism, comprising the application of compound I, or a composition including compound I to soil, a plant, a part of a plant, foliage, and/or seeds.

Additionally, another embodiment of the present disclosure is a composition useful for protecting a plant against attack by a phytopathogenic organism and/or treatment of a plant infested by a phytopathogenic organism comprising compound I and a phytologically acceptable carrier material.

### DETAILED DESCRIPTION

One exemplary embodiment of the present disclosure includes mixture for controlling the growth of fungi, the mixture including compound I:

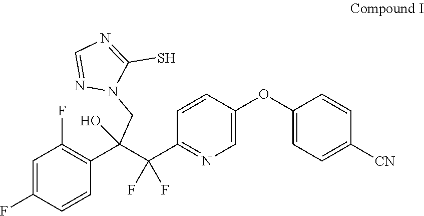 [SMILES: N#Cc1ccc(Oc2ccc(C(F)(F)C(O)(Cn3ncnc3S)c3ccc(F)cc3F)nc2)cc1]

Compound I of the present disclosure may be applied by any of a variety of known techniques, either as compound I or as formulations comprising compound I. For example, compound I may be applied to the roots, stems, seeds, flowers, or foliage of plants for the control of various fungi, without damaging the commercial value of the plants. Compound I may also be applied as a foliar spray, soil drench, soil injection, or seed treatment. The material may be applied in the form of any of the generally used formulation types, for example, as solutions, dusts, wettable powders, flowable concentrates, or emulsifiable concentrates.

Preferably, compound I of the present disclosure is applied in the form of a formulation, including compound I with a phytologically acceptable carrier. Concentrated formulations may be dispersed in water or other liquids for application, or formulations may be dust-like or granular, which may then be applied without further treatment. The formulations can be prepared according to procedures that are conventional in the agricultural chemical art.

The present disclosure contemplates all vehicles by which compound I may be formulated for delivery and use as a fungicide. Typically, formulations are applied as aqueous suspensions or emulsions. Such suspensions or emulsions may be produced from water-soluble, water-suspendible, or emulsifiable formulations which are solids, usually known as wettable powders; or liquids, usually known as emulsifiable concentrates, aqueous suspensions, or suspension concentrates. As will be readily appreciated, any material to which compound I may be added may be used, provided it yields the desired utility without significant interference with the activity of compound I as an antifungal agent.

Wettable powders, which may be compacted to form water-dispersible granules, comprise an intimate mixture including compound I, an inert carrier and surfactants. The concentration of compound I in the wettable powder may be from about 10 percent to about 90 percent by weight based on the total weight of the wettable powder, more preferably about 25 weight percent to about 75 weight percent. In the preparation of wettable powder formulations, compound I may be compounded with any finely divided solid, such as prophyllite, talc, chalk, gypsum, Fuller's earth, bentonite, attapulgite, starch, casein, gluten, montmorillonite clays, diatomaceous earths, purified silicates or the like. In such operations, the finely divided carrier and surfactants are typically blended with compound I and milled.

Emulsifiable concentrates of compound I may comprise a convenient concentration, such as from about 10 weight percent to about 50 weight percent of compound I, in a suitable liquid, based on the total weight of the concentrate. Compound I may be dissolved in an inert carrier, which is either a water-miscible solvent or a mixture of water-immiscible organic solvents, and emulsifiers. The concentrates may be diluted with water and oil to form spray mixtures in the form of oil-in-water emulsions. Useful organic solvents include aromatics, especially the high-boiling naphthalenic and olefinic portions of petroleum, such as heavy aromatic naphtha. Other organic solvents may also be used, for example, terpenic solvents, including rosin derivatives, aliphatic ketones, such as cyclohexanone, and complex alcohols, such as 2-ethoxyethanol.

Emulsifiers which may be advantageously employed herein may be readily determined by those skilled in the art and include various nonionic, anionic, cationic and amphoteric emulsifiers, or a blend of two or more emulsifiers. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil-soluble salts (e.g., calcium) of alkylaryl sulphonic acids, oil-soluble salts or sulfated polyglycol ethers and appropriate salts of phosphated polyglycol ether.

Representative organic liquids which may be employed in preparing the emulsifiable concentrates of compound I of the present invention are the aromatic liquids such as xylene, propyl benzene fractions; or mixed naphthalene fractions, mineral oils, substituted aromatic organic liquids such as dioctyl phthalate; kerosene; dialkyl amides of various fatty acids, particularly the dimethyl amides of fatty glycols and glycol derivatives such as the n-butyl ether, ethyl ether or methyl ether of diethylene glycol, and the methyl ether of triethylene glycol and the like. Mixtures of two or more organic liquids may also be employed in the preparation of the emulsifiable concentrate. Organic liquids include xylene, and propyl benzene fractions, with xylene being most preferred in some cases. Surface-active dispersing agents are typically employed in liquid formulations and in an amount of from 0.1 to 20 percent by weight based on the combined weight of the dispersing agent with compound I. The formulations can also contain other compatible additives, for example, plant growth regulators and other biologically active compounds used in agriculture.

Aqueous suspensions including compound I may be dispersed in an aqueous vehicle at a concentration in the range from about 5 to about 50 weight percent, based on the total weight of the aqueous suspension. Suspensions are prepared by finely grinding compound I, and vigorously mixing the ground material into a vehicle comprised of water and surfactants chosen from the same types discussed above. Other components, such as inorganic salts and synthetic or natural gums, may also be added to increase the density and viscosity of the aqueous vehicle.

Compound I may also be applied as a granular formulation, which is particularly useful for applications to the soil. Granular formulations generally contain from about 0.5 to about 10 weight percent, based on the total weight of the granular formulation of compound I, dispersed in an inert carrier which consists entirely or in large part of coarsely divided inert material such as attapulgite, bentonite, diatomite, clay or a similar inexpensive substance. Such formulations are usually prepared by dissolving compound I in a suitable solvent and applying it to a granular carrier which has been preformed to the appropriate particle size, in the range of from about 0.5 to about 3 mm. A suitable solvent is a solvent in which compound I is substantially or completely soluble. Such formulations may also be prepared by making a dough or paste of the carrier and compound I and solvent, and crushing and drying to obtain the desired granular particle.

Dusts containing compound I may be prepared by intimately mixing compound I in powdered form with a suitable dusty agricultural carrier, such as, for example, kaolin clay, ground volcanic rock, and the like. Dusts can suitably contain from about 1 to about 10 weight percent of compound I, based on the total weight of the dust.

The formulations may additionally contain adjuvant surfactants to enhance deposition, wetting and penetration of compound I onto the target crop and organism. These adjuvant surfactants may optionally be employed as a component of the formulation or as a tank mix. The amount of adjuvant surfactant will typically vary from 0.01 to 1.0 percent by volume, based on a spray-volume of water, preferably 0.05 to 0.5 volume percent. Suitable adjuvant surfactants include, but are not limited to ethoxylated nonyl phenols, ethoxylated synthetic or natural alcohols, salts of the esters or sulphosuccinic acids, ethoxylated organosilicones, ethoxylated fatty amines and blends of surfactants with mineral or vegetable oils. The formulations may also include oil-in-water emulsions such as those disclosed in U.S. patent application Ser. No. 11/495,228, the disclosure of which is expressly incorporated by reference herein.

The formulations may optionally include combinations that contain other pesticidal compounds. Such additional pesticidal compounds may be fungicides, insecticides, herbicides, nematocides, miticides, arthropodicides, bactericides or combinations thereof that are compatible with the compounds of the present invention in the medium selected for application, and not antagonistic to the activity of the present compounds. Accordingly, in such embodiments, the other pesticidal compound is employed as a supplemental toxicant for the same or for a different pesticidal use. Compound I and the pesticidal compound in the combination can generally be present in a weight ratio of from 1:100 to 100:1.

Compound I of the present disclosure may also be combined with other fungicides to form fungicidal mixtures and synergistic mixtures thereof. Compound I of the present disclosure is often applied in conjunction with one or more other fungicides to control a wider variety of undesirable diseases. When used in conjunction with other fungicide(s), the presently claimed compound I may be formulated with the other fungicide(s), tank-mixed with the other fungicide(s) or applied sequentially with the other fungicide(s). Such other fungicides may include 2-(thiocyanatomethylthio)-benzothiazole, 2-phenylphenol, 8-hydroxyquinoline sulfate, ametoctradin, amisulbrom, antimycin, Ampelomyces quisqualis, azaconazole, azoxystrobin, Bacillus subtilis, Bacillus subtilis strain QST713, benalaxyl, benomyl, benthiavalicarb-isopropyl, benzylaminobenzene-sulfonate (BABS) salt, bicarbonates, biphenyl, bismerthiazol, bitertanol, bixafen, blasticidin-S, borax, Bordeaux mixture, boscalid, bromuconazole, bupirimate, calcium polysulfide, captafol, captan, carbendazim, carboxin, carpropamid, carvone, chlazafenone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, enestrobin, enestroburin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutianil, flutolanil, flutriafol, fluxapyroxad, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), iodocarb, ipconazole, ipfenpyrazolone, iprobenfos, iprodione, iprovalicarb, isoprothiolane, isopyrazam, isotianil, kasugamycin, kasugamycin hydrochloride hydrate, kresoxim-methyl, laminarin, mancopper, mancozeb, mandipropamid, maneb, mefenoxam, mepanipyrim, mepronil, meptyl-dinocap, mercuric chloride, mercuric oxide, mercurous chloride, metalaxyl, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, penflufen, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrametostrobin, pyraoxystrobin, pyrazophos, pyribencarb, pyributicarb, pyrifenox, pyrimethanil, pyriofenone, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, valifenalate, valiphenal, vinclozolin, zineb, ziram, zoxamide, Candida oleophila, Fusarium oxysporum, Gliocladium spp., Phlebiopsis gigantea, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme, ampropylfos, anilazine, azithiram, barium polysulfide, Bayer 32394, benodanil, benquinox, bentaluron, benzamacril; benzamacril-isobutyl, benzamorf, benzovindiflupyr, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, coumoxystrobin, cufraneb, cupric hydrazinium sulfate, cuprobam, cyclafuramid, cypendazole, cyprofuram, decafentin, dichlobentiazox, dichlone, dichlozoline, diclobutrazol, dimethirimol, dinocton, dinosulfon, dinoterbon, dipymetitrone, dipyrithione, ditalimfos, dodicin, drazoxolon, EBP, enoxastrobin, ESBP, etaconazole, etem, ethirim, fenaminosulf, fenaminstrobin, fenapanil, fenitropan, fenpicoxamid, fluindapyr, fluotrimazole, flufenoxystrobin, furcarbanil, furconazole, furconazole-cis, furmecyclox, furophanate, glyodine, griseofulvin, halacrinate, Hercules 3944, hexylthiofos, ICIA0858, ipfentrifluconazole, isofetamid, isopamphos, isovaledione, mandestrobin, mebenil, mecarbinzid, mefentrifluconazole, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, oxathiapiprolin, phenylmercury dimethyldithiocarbamate, phenylmercury nitrate, phosdiphen, prothiocarb; prothiocarb hydrochloride, pydiflumetofen, pyracarbolid, pyraziflumid, pyridinitril, pyrisoxazole, pyroxychlor, pyroxyfur, quinacetol, quinacetol sulfate, quinazamid, quinconazole, quinofumelin, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, triclopyricarb, triflumezopyrim, urbacid, zarilamid, and any combinations thereof.

Additionally, compound I of the present invention may be combined with other pesticides, including insecticides, nematicides, miticides, arthropodicides, bactericides or combinations thereof that are compatible with compound I of the present invention in the medium selected for application, and not antagonistic to the activity of compound I, to form pesticidal mixtures and synergistic mixtures thereof. Compound I of the present disclosure may be applied in conjunction with one or more other pesticides to control a wider variety of undesirable pests. When used in conjunction with other pesticides, the presently claimed compound I may be formulated with the other pesticide(s), tank mixed with the other pesticide(s) or applied sequentially with the other pesticide(s). Typical insecticides include, but are not limited to: 1,2-dichloropropane, abamectin, acephate, acetamiprid, acethion, acetoprole, acrinathrin, acrylonitrile, alanycarb, aldicarb, aldoxycarb, aldrin, allethrin, allosamidin, allyxycarb, alpha-cypermethrin, alpha-ecdysone, alpha-endosulfan, amidithion, aminocarb, amiton, amiton oxalate, amitraz, anabasine, athidathion, azadirachtin, azamethiphos, azinphos-ethyl, azinphos-methyl, azothoate, barium hexafluorosilicate, barthrin, bendiocarb, benfuracarb, bensultap, beta-cyfluthrin, beta-cypermethrin, bifenthrin, bioallethrin, bioethanomethrin, biopermethrin, bistrifluron, borax, boric acid, bromfenvinfos, bromocyclen, bromo-DDT, bromophos, bromophos-ethyl, bufencarb, buprofezin, butacarb, butathiofos, butocarboxim, butonate, butoxycarboxim, cadusafos, calcium arsenate, calcium polysulfide, camphechlor, carbanolate, carbaryl, carbofuran, carbon disulfide, carbon tetrachloride, carbophenothion, carbosulfan, cartap, cartap hydrochloride, chlorantraniliprole, chlorbicyclen, chlordane, chlordecone, chlordimeform, chlordimeform hydrochloride, chlorethoxyfos, chlorfenapyr, chlorfenvinphos, chlorfluazuron, chlormephos, chloroform, chloropicrin, chlorphoxim, chlorprazophos, chlorpyrifos, chlorpyrifos-methyl, chlorthiophos, chromafenozide, cinerin I, cinerin II, cinerins, cismethrin, cloethocarb, closantel, clothianidin, copper acetoarsenite, copper arsenate, copper naphthenate, copper oleate, coumaphos, coumithoate, crotamiton, crotoxyphos, crufomate, cryolite, cyanofenphos, cyanophos, cyanthoate, cyantraniliprole, cyclethrin, cycloprothrin, cyfluthrin, cyhalothrin, cypermethrin, cyphenothrin, cyromazine, cythioate, DDT, decarbofuran, deltamethrin, demephion, demephion-O, demephion-S, demeton, demeton-methyl, demeton-O, demeton-O-methyl, demeton-S, demeton-S-methyl, demeton-S-methylsulphon, diafenthiuron, dialifos, diatomaceous earth, diazinon, dicapthon, dichlofenthion, dichlorvos, dicresyl, dicrotophos, dicyclanil, dieldrin, diflubenzuron, dilor, dimefluthrin, dimefox, dimetan, dimethoate, dimethrin, dimethylvinphos, dimetilan, dinex, dinex-diclexine, dinoprop, dinosam, dinotefuran, diofenolan, dioxabenzofos, dioxacarb, dioxathion, disulfoton, dithicrofos, d-limonene, DNOC, DNOC-ammonium, DNOC-potassium, DNOC-sodium, doramectin, ecdysterone, emamectin, emamectin benzoate, EMPC, empenthrin, endosulfan, endothion, endrin, EPN, epofenonane, eprinomectin, esdepalldthrine, esfenvalerate, etaphos, ethiofencarb, ethion, ethiprole, ethoate-methyl, ethoprophos, ethyl formate, ethyl-DDD, ethylene dibromide, ethylene dichloride, ethylene oxide, etofenprox, etrimfos, EXD, famphur, fenamiphos, fenazaflor, fenchlorphos, fenethacarb, fenfluthrin, fenitrothion, fenobucarb, fenoxacrim, fenoxycarb, fenpirithrin, fenpropathrin, fensulfothion, fenthion, fenthion-ethyl, fenvalerate, fipronil, flonicamid, flubendiamide, flucofuron, flucycloxuron, flucythrinate, flufenerim, flufenoxuron, flufenprox, fluvalinate, fonofos, formetanate, formetanate hydrochloride, formothion, formparanate, formparanate hydrochloride, fosmethilan, fospirate, fosthietan, furathiocarb, furethrin, gamma-cyhalothrin, gamma-HCH, halfenprox, halofenozide, HCH, HEOD, heptachlor, heptenophos, heterophos, hexaflumuron, HHDN, hydramethylnon, hydrogen cyanide, hydroprene, hyquincarb, imidacloprid, imiprothrin, indoxacarb, iodomethane, IPSP, isazofos, isobenzan, isocarbophos, isodrin, isofenphos, isofenphos-methyl, isoprocarb, isoprothiolane, isothioate, isoxathion, ivermectin, jasmolin I, jasmolin II, jodfenphos, juvenile hormone I, juvenile hormone II, juvenile hormone III, kelevan, kinoprene, lambda-cyhalothrin, lead arsenate, lepimectin, leptophos, lindane, lirimfos, lufenuron, lythidathion, malathion, malonoben, mazidox, mecarbam, mecarphon, menazon, mephosfolan, mercurous chloride, mesulfenfos, metaflumizone, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, molosultap, monocrotophos, monomehypo, monosultap, morphothion, moxidectin, naftalofos, naled, naphthalene, nicotine, nifluridide, nitenpyram, nithiazine, nitrilacarb, novaluron, noviflumuron, omethoate, oxamyl, oxydemeton-methyl, oxydeprofos, oxydisulfoton, para-dichlorobenzene, parathion, parathion-methyl, penfluron, pentachlorophenol, permethrin, phenkapton, phenothrin, phenthoate, phorate, phosalone, phosfolan, phosmet, phosnichlor, phosphamidon, phosphine, phoxim, phoxim-methyl, pirimetaphos, pirimicarb, pirimiphos-ethyl, pirimiphos-methyl, potassium arsenite, potassium thiocyanate, pp′-DDT, prallethrin, precocene I, precocene II, precocene III, primidophos, profenofos, profluralin, promacyl, promecarb, propaphos, propetamphos, propoxur, prothidathion, prothiofos, prothoate, protrifenbute, pyraclofos, pyrafluprole, pyrazophos, pyresmethrin, pyrethrin I, pyrethrin II, pyrethrins, pyridaben, pyridalyl, pyridaphenthion, pyrifluquinazon, pyrimidifen, pyrimitate, pyriprole, pyriproxyfen, quassia, quinalphos, quinalphos-methyl, quinothion, rafoxanide, resmethrin, rotenone, ryania, sabadilla, schradan, selamectin, silafluofen, silica gel, sodium arsenite, sodium fluoride, sodium hexafluorosilicate, sodium thiocyanate, sophamide, spinetoram, spinosad, spiromesifen, spirotetramat, sulcofuron, sulcofuron-sodium, sulfluramid, sulfotep, sulfoxaflor, sulfuryl fluoride, sulprofos, tau-fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetramethrin, tetramethylfluthrin, theta-cypermethrin, thiacloprid, thiamethoxam, thicrofos, thiocarboxime, thiocyclam, thiocyclam oxalate, thiodicarb, thiofanox, thiometon, thiosultap, thiosultap-disodium, thiosultap-monosodium, thuringiensin, tolfenpyrad, tralomethrin, transfluthrin, transpermethrin, triarathene, triazamate, triazophos, trichlorfon, trichlormetaphos-3, trichloronat, trifenofos, triflumuron, trimethacarb, triprene, vamidothion, vaniliprole, XMC, xylylcarb, zeta-cypermethrin, zolaprofos, and any combinations thereof.

Additionally, compound I of the present invention may be combined with herbicides that are compatible with compound I of the present invention in the medium selected for application, and not antagonistic to the activity of compound I to form pesticidal mixtures and synergistic mixtures thereof. The fungicidal compound I of the present disclosure may be applied in conjunction with one or more herbicides to control a wide variety of undesirable plants. When used in conjunction with herbicides, the presently claimed compound I may be formulated with the herbicide(s), tank mixed with the herbicide(s) or applied sequentially with the herbicide(s). Typical herbicides include, but are not limited to: 4-CPA; 4-CPB; 4-CPP; 2,4-D; 3,4-DA; 2,4-DB; 3,4-DB; 2,4-DEB; 2,4-DEP; 3,4-DP; 2,3,6-TBA; 2,4,5-T; 2,4,5-TB; acetochlor, acifluorfen, aclonifen, acrolein, alachlor, allidochlor, alloxydim, allyl alcohol, alorac, ametridione, ametryn, amibuzin, amicarbazone, amidosulfuron, aminocyclopyrachlor, aminopyralid, amiprofos-methyl, amitrole, ammonium sulfamate, anilofos, anisuron, asulam, atraton, atrazine, azafenidin, azimsulfuron, aziprotryne, barban, BCPC, beflubutamid, benazolin, bencarbazone, benfluralin, benfuresate, bensulfuron, bensulide, bentazone, benzadox, benzfendizone, benzipram, benzobicyclon, benzofenap, benzofluor, benzoylprop, benzthiazuron, bicyclopyrone, bifenox, bilanafos, bispyribac, borax, bromacil, bromobonil, bromobutide, bromofenoxim, bromoxynil, brompyrazon, butachlor, butafenacil, butamifos, butenachlor, buthidazole, buthiuron, butralin, butroxydim, buturon, butylate, cacodylic acid, cafenstrole, calcium chlorate, calcium cyanamide, cambendichlor, carbasulam, carbetamide, carboxazole chlorprocarb, carfentrazone, CDEA, CEPC, chlomethoxyfen, chloramben, chloranocryl, chlorazifop, chlorazine, chlorbromuron, chlorbufam, chloreturon, chlorfenac, chlorfenprop, chlorflurazole, chlorflurenol, chloridazon, chlorimuron, chlornitrofen, chloropon, chlorotoluron, chloroxuron, chloroxynil, chlorpropham, chlorsulfuron, chlorthal, chlorthiamid, cinidon-ethyl, cinmethylin, cinosulfuron, cisanilide, clethodim, cliodinate, clodinafop, clofop, clomazone, clomeprop, cloprop, cloproxydim, clopyralid, cloransulam, CMA, copper sulfate, CPMF, CPPC, credazine, cresol, cumyluron, cyanatryn, cyanazine, cycloate, cyclosulfamuron, cycloxydim, cycluron, cyhalofop, cyperquat, cyprazine, cyprazole, cypromid, daimuron, dalapon, dazomet, delachlor, desmedipham, desmetryn, di-allate, dicamba, dichlobenil, dichloralurea, dichlormate, dichlorprop, dichlorprop-P, diclofop, diclosulam, diethamquat, diethatyl, difenopenten, difenoxuron, difenzoquat, diflufenican, diflufenzopyr, dimefuron, dimepiperate, dimethachlor, dimethametryn, dimethenamid, dimethenamid-P, dimexano, dimidazon, dinitramine, dinofenate, dinoprop, dinosam, dinoseb, dinoterb, diphenamid, dipropetryn, diquat, disul, dithiopyr, diuron, DMPA, DNOC, DSMA, EBEP, eglinazine, endothal, epronaz, EPTC, erbon, esprocarb, ethalfluralin, ethametsulfuron, ethidimuron, ethiolate, ethofumesate, ethoxyfen, ethoxysulfuron, etinofen, etnipromid, etobenzanid, EXD, fenasulam, fenoprop, fenoxaprop, fenoxaprop-P, fenoxasulfone, fenteracol, fenthiaprop, fentrazamide, fenuron, ferrous sulfate, flamprop, flamprop-M, flazasulfuron, florasulam, fluazifop, fluazifop-P, fluazolate, flucarbazone, flucetosulfuron, fluchloralin, flufenacet, flufenican, flufenpyr, flumetsulam, flumezin, flumiclorac, flumioxazin, flumipropyn, fluometuron, fluorodifen, fluoroglycofen, fluoromidine, fluoronitrofen, fluothiuron, flupoxam, flupropacil, flupropanate, flupyrsulfuron, fluridone, flurochloridone, fluroxypyr, flurtamone, fluthiacet, fomesafen, foramsulfuron, fosamine, furyloxyfen, glufosinate, glufosinate-P, glyphosate, halosafen, halosulfuron, haloxydine, haloxyfop, haloxyfop-P, hexachloroacetone, hexaflurate, hexazinone, imazamethabenz, imazamox, imazapic, imazapyr, imazaquin, imazethapyr, imazosulfuron, indanofan, indaziflam, iodobonil, iodomethane, iodosulfuron, ioxynil, ipazine, ipfencarbazone, iprymidam, isocarbamid, isocil, isomethiozin, isonoruron, isopolinate, isopropalin, isoproturon, isouron, isoxaben, isoxachlortole, isoxaflutole, isoxapyrifop, karbutilate, ketospiradox, lactofen, lenacil, linuron, MAA, MAMA, MCPA, MCPA-thioethyl, MCPB, mecoprop, mecoprop-P, medinoterb, mefenacet, mefluidide, mesoprazine, mesosulfuron, mesotrione, metam, metamifop, metamitron, metazachlor, metazosulfuron, metflurazon, methabenzthiazuron, methalpropalin, methazole, methiobencarb, methiozolin, methiuron, methometon, methoprotryne, methyl bromide, methyl isothiocyanate, methyldymron, metobenzuron, metobromuron, metolachlor, metosulam, metoxuron, metribuzin, metsulfuron, molinate, monalide, monisouron, monochloroacetic acid, monolinuron, monuron, morfamquat, MSMA, naproanilide, napropamide, naptalam, neburon, nicosulfuron, nipyraclofen, nitralin, nitrofen, nitrofluorfen, norflurazon, noruron, OCH, orbencarb, ortho-dichlorobenzene, orthosulfamuron, oryzalin, oxadiargyl, oxadiazon, oxapyrazon, oxasulfuron, oxaziclomefone, oxyfluorfen, parafluron, paraquat, pebulate, pelargonic acid, pendimethalin, penoxsulam, pentachlorophenol, pentanochlor, pentoxazone, perfluidone, pethoxamid, phenisopham, phenmedipham, phenmedipham-ethyl, phenobenzuron, phenylmercury acetate, picloram, picolinafen, pinoxaden, piperophos, potassium arsenite, potassium azide, potassium cyanate, pretilachlor, primisulfuron, procyazine, prodiamine, profluazol, profluralin, profoxydim, proglinazine, prometon, prometryn, propachlor, propanil, propaquizafop, propazine, propham, propisochlor, propoxycarbazone, propyrisulfuron, propyzamide, prosulfalin, prosulfocarb, prosulfuron, proxan, prynachlor, pydanon, pyraclonil, pyraflufen, pyrasulfotole, pyrazolynate, pyrazosulfuron, pyrazoxyfen, pyribenzoxim, pyributicarb, pyriclor, pyridafol, pyridate, pyriftalid, pyriminobac, pyrimisulfan, pyrithiobac, pyroxasulfone, pyroxsulam, quinclorac, quinmerac, quinoclamine, quinonamid, quizalofop, quizalofop-P, rhodethanil, rimsulfuron, saflufenacil, S-metolachlor, sebuthylazine, secbumeton, sethoxydim, siduron, simazine, simeton, simetryn, SMA, sodium arsenite, sodium azide, sodium chlorate, sulcotrione, sulfallate, sulfentrazone, sulfometuron, sulfosulfuron, sulfuric acid, sulglycapin, swep, TCA, tebutam, tebuthiuron, tefuryltrione, tembotrione, tepraloxydim, terbacil, terbucarb, terbuchlor, terbumeton, terbuthylazine, terbutryn, tetrafluron, thenylchlor, thiazafluron, thiazopyr, thidiazimin, thidiazuron, thiencarbazone-methyl, thifensulfuron, thiobencarb, tiocarbazil, tioclorim, topramezone, tralkoxydim, triafamone, tri-allate, triasulfuron, triaziflam, tribenuron, tricamba, triclopyr, tridiphane, trietazine, trifloxysulfuron, trifluralin, triflusulfuron, trifop, trifopsime, trihydroxytriazine, trimeturon, tripropindan, tritac, tritosulfuron, vernolate, and xylachlor.

One embodiment of the present disclosure is a method for the control or prevention of fungal attack. This method comprises applying to the soil, plant, roots, foliage, seed or locus of the fungus, or to a locus in which the infestation is to be prevented (for example applying to cereal or grape plants), a fungicidal effective amount of compound I. Compound I is suitable for treatment of various plants at fungicidal levels, while exhibiting low phytotoxicity. Compound I may be useful both in a protectant and/or an eradicant fashion.

Compound I has been found to have significant fungicidal effects on phytopathogenic fungi of wheat. These diseases include, but are not limited to, Puccinia recondita, which causes brown rust of wheat; Puccinia striiformis, which causes yellow rust of wheat; Parastagonospora nodorum, which causes wheat glume blotch; a mixture of Fusarium graminearum and Fusarium culmorum, which causes Fusarium head blight (FHB) in wheat; and Blumeria graminis f. sp. tritici, which causes powdery mildew of wheat; particularly for agricultural use. Compound I is particularly effective for use with agricultural crops and horticultural plants.

It will be understood by those in the art that the efficacy of the compound for the foregoing fungi establishes the general utility of compound I as a fungicide. In particular, the composition is effective in controlling a variety of undesirable fungi that infect useful plant crops. The composition maybe used against a variety of Ascomycete and Basidiomycete fungi, including for example the following representative fungi species: Alternaria leaf blight (Alternaria triticina), anthracnose (Glomerella graminicola, Colletotrichum graminicola), Ascochyta leaf spot (Ascochyta tritici), Aureobasidium decay (Microdochium bolleyi, Aureobasidium bolleyi), black head molds, sooty molds (Alternaria spp., Cladosporium spp., Epicoccum spp., Sporobolomyces spp., Stemphylium spp.), black point, kernel smudge (Alternaria spp., Cochliobolus sativus, Cladosporium spp.), Cephalosporium stripe (Hymenula cerealis, Cephalosporium gramineum), common bunt=stinking smut (Tilletia spp.), common root rot (Cochliobolus sativus, Bipolaris sorokiniana, Helminthosporium sativum), cottony snow mold (Coprinus psychromorbidus), crown rot, foot rot, seedling blight, dryland root rot (Fusarium spp., Gibberella spp.), Dilophospora leaf spot, twist (Dilophospora alopecuri), dwarf bunt (Tilletia controversa), ergot (Claviceps purpurea, Sphacelia segetum), eyespot, foot rot, strawbreaker (Tapesia yallundae, Ramulispora herpotrichoides, Pseudocercosporella herpotrichoides, Tapesia acuformis, Ramulispora acuformis, Pseudocercosporella herpotrichoides var. acuformis), false eyespot (Gibellina cerealis), flag smut (Urocystis agropyri), halo spot (Pseudoseptoria donacis, Selenophoma donacis), karnal bunt, partial bunt (Tilletia indica, Neovossia indica), rusts (Puccinia spp.), Leptosphaeria leaf spot (Phaeosphaeria herpotrichoides, Leptosphaeria herpotrichoides, Stagonospora), loose smut (Ustilago spp.), Microscopica leaf spot (Phaeosphaeria microscopica, Leptosphaeria microscopica), Phoma spot (Phoma spp.), pink snow mold, Fusarium patch (Microdochium nivale, Fusarium nivale, Monographella nivalis), Platyspora leaf spot (Clathrospora pentamera, Platyspora pentamera), powdery mildew (Erysiphe graminis f.sp. tritici, Blumeria graminis, Erysiphe graminis, Oidium monilioides), Rhizoctonia root rot (Rhizoctonia solani, Thanatephorus cucumeris), scab, head blight, Fusarium head blight (FHB) (Fusarium spp., Gibberella spp., Microdochium nivale, Monographella nivalis), Sclerotinia snow mold, snow scald (Myriosclerotinia borealis, Sclerotinia borealis), Sclerotium wilt, Southern blight, Sclerotium base rot (Sclerotium rolfsii, Athelia rolfsii), Septoria blotch (Septoria tritici, Mycosphaerella graminicola), sharp eyespot (Rhizoctonia cerealis, Ceratobasidium cereale), speckled snow mold, gray snow mold, Typhula blight (Typhula spp.), spot blotch (Cochliobolus sativus, Bipolaris sorokiniana, Helminthosporium sativum), Stagonospora blotch (Phaeosphaeria spp., Stagonospora spp., Septoria spp.), storage molds (Aspergillus spp., Penicillium spp.), take-all (Gaeumannomyces graminis), tan spot, yellow leaf spot, red smudge (Pyrenophora tritici-repentis, Drechslera tritici-repentis), tar spot (Phyllachora graminis, Linochora graminis) and wheat blast (Magnaporthe grisea).

Compound I has a broad range of efficacy as a fungicide. The exact amount of the active material to be applied is dependent not only on the specific active material being applied, but also on the particular action desired, the fungal species to be controlled, and the stage of growth thereof, as well as the part of the plant or other product to be contacted with the compound. Thus, compound I, and formulations containing the same, may not be equally effective at similar concentrations or against the same fungal species.

Compound I is effective in use with plants in a disease-inhibiting and phytologically acceptable amount. The term “disease-inhibiting and phytologically acceptable amount” refers to an amount of a compound that kills or inhibits the plant disease for which control is desired, but is not significantly toxic to the plant. This amount will generally be from about 0.1 to about 1000 ppm (parts per million), with 1 to 500 ppm being preferred. The exact concentration of compound required varies with the fungal disease to be controlled, the type of formulation employed, the method of application, the particular plant species, climate conditions, and the like. A suitable application rate is typically in the range from about 0.10 to about 4 pounds/acre (about 0.01 to 0.45 grams per square meter, g/m²).

Any range or desired value given herein may be extended or altered without losing the effects sought, as is apparent to the skilled person for an understanding of the teachings herein.

### EXAMPLES

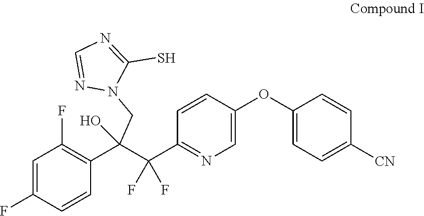 [SMILES: N#Cc1ccc(Oc2ccc(C(F)(F)C(O)(Cn3ncnc3S)c3ccc(F)cc3F)nc2)cc1]

Field Assessment of Puccinia recondita (PUCCRT) in Spring Wheat:

A fungicidal treatment containing Compound I, applied alone in an EC formulation at 50 and 100 grams of active ingredient per hectare (g ai/ha), and tank mixed with an adjuvant (Agnique BP-420, 50% w/w at 0.3% v/v), was applied twice at B37-39 (early curative, approximately 1-2% infection at application) and B41-49 (late curative, approximately 5% infection at application) growth stages of spring wheat (TRZAS, Peg variety) at a rate of 25, 50, 100 and 150 g ai/ha under natural infection of brown rust. The treatment was part of an experimental trial designed as a randomized complete block with four replications and a plot of approximately 1×1.2 m. Compound I was applied at water volume of 200 L/ha, using a precision plot sprayer (PRECICO2, 1 m band width, 1×95015 EVS Nozzle) and pressurized at 220 kPa.

Disease severity (percentage of visual diseased foliage on whole plot) was assessed five times during the early curative application (15-32 days after application, DAA) and assessed four times during the late curative field trial (12-25 days after application, DAA). The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 1.

Field Assessment of Puccinia striiformis (PUCCST) in Winter Wheat:

A fungicidal treatment containing Compound I was assessed against yellow rust of wheat (PUCCST) in three separate field trials. In each trial, all Compound I treatments were applied in a tank mix with Trycol 5941 (50% w/w) at 0.2% v/v as an adjuvant. In the first trial, a fungicidal treatment containing Compound I was applied at B32-33 (early curative, 3% infection at application) growth stage of winter wheat (TRZAS, Robigus variety) at a rate of 50, 100 and 200 g ai/ha under natural infection of yellow rust. The treatment was part of an experimental trial designed as a randomized complete block with four replications and a plot of approximately 1×2 m. Treatments were applied at water volume of 200 L/ha, using a backpack plot sprayer (BKPCKAIR, 1 m band width, FLATFAN F110-03 Lurmark nozzle) and pressurized at 180 kPa. Disease severity (% visual infection) was assessed 4 times on leaf 1 (L1, flag leaf, 33-47 DAA) and 5 times on leaf 2 (L2, 27-54 DAA).

In the second trial, wheat plants were artificially inoculated with Puccinia striiformis at B31 growth stage of wheat five days before treatment with Compound I. A fungicidal treatment containing Compound I was applied twice at B31-32 (early curative, 2.3% infection at application) and B37-39 (late curative) growth stages of wheat (TRZSS, Fairplay variety) at a rate of 50, 100 and 200 g ai/ha. The treatment was part of an experimental trial designed as a randomized complete block with four replications and a plot of approximately 2×3 m. Treatments were applied at water volume of 200 L/ha, using a backpack precision plot sprayer (BKCKENG, 2 m band width, FFA110-015 Hardi nozzle) and pressurized at 200 kPa. Disease severity (% visual infection) was assessed following application A one time on leaf 2 (23 DAA). Following application B, disease severity was assessed 4 times on leaf 1 (11-45 DAA) and 3 times on leaf 2 (11-31 DAA).

In the final trial, wheat plants were artificially inoculated with Puccinia striiformis at B25 growth stage of wheat 19 days before treatment with Compound I. A fungicidal treatment containing Compound I was applied twice approximately three weeks apart at approximately B32-37 growth stages of wheat (TRZSS, Substance variety) at a rate of 50, 100 and 200 g ai/ha. The treatment was part of an experimental trial designed as a randomized complete block with four replications and a plot of approximately 2×3 m. Treatments were applied at water volume of 150 L/ha, using a backpack precision plot sprayer (TRACTAIR, 2 m band width, FLAT FAN FF015 nozzle). Disease severity (% visual infection) was assessed 3 times on leaf 1 (47-68 DAA) and 4 times on leaf 2 (36-68 DAA).

Disease severity (percentage of visual diseased foliage on whole plot or leaves) in all three field trials was recorded following EPPO PP1/26 guideline prescriptions. Area under the disease progress curve (AUDPC) was calculated for each plot in each of the three trials using the sets of recorded severity data. Relative AUDPC (% control based on AUDPC) was calculated as percent of the nontreated control. Final results for the control of stripe rust on wheat by compound I (Table 2) are reported as an average of the relative AUDPC calculated over all three field trials.

Field Assessment of Parastagonospora nodorum (LEPTNO) in Spring Wheat:

A fungicidal treatment containing Compound I, sprayed alone in an EC formulation at 50 g ai/ha and tank mixed with an adjuvant (Agnique BP-420, 50% w/w at 0.3% v/v), was applied at B37-39 growth stage of spring wheat (TRZAS, Lancer variety) for protectant tests at rates of 25, 50, 100 and 150 g ai/ha. After three days, the wheat plants were artificially inoculated with Parastagonospora nodorum at B39 growth stage of wheat. Compound I was then applied two days later (same rates and formulations) to the plants at B39-41 growth stage of wheat (2 day curative test). The treatment was part of an experimental trial designed as a randomized complete block with four replications and a plot of approximately 1×2 m. Treatments were applied at water volume of 200 L/ha, using a precision plot sprayer (PRECICO2, 1 m band width, 1×95015 EVS Nozzle) and pressurized at 220 kPa.

Disease severity (percentage of visual diseased foliage on whole plot) was assessed four times during the protectant application (14-26 DAA) and assessed three times during the curative field trial (7-17 DAA) under artificial inoculation of glume blotch of wheat. The disease infection was recorded following EPPO PP1/26 guideline prescriptions. Area under the disease progress curve (AUDPC) was calculated for each plot using the sets of recorded severity data. Relative AUDPC (% control based on AUDPC) was calculated as percent of the nontreated control. Results are given in Table 3.

### Field Assessment of Fusarium Head Blight (FHB) in Winter Wheat:

At the time of flowering of winter wheat (BBCH 61), Compound I (tank mixed with Agnique BP-420 (50% w/w at 0.3% v/v) as an adjuvant) was sprayed on the heads (TRZAW, Tobak variety) at a rate of 100 g ai/ha. The treatment was part of an experimental trial designed as a randomized complete block with four replications and a plot of approximately 2.5×9 m. Compound I was applied at a water volume of 200 L/ha, using a backpack precision plot sprayer (BICYCAIR, 250 cm band width, FLATFAND TTJ60-11003 Nozzle) and pressurized at 220 kPa. The following day, plants were inoculated with a mixture of Fusarium graminearum and Fusarium culmorum isolates. Directly after inoculation, the trial site was irrigated for 24 hr to keep the heads moist to promote disease infections. Incidence and severity (percentage of infection relative to control plants) of FHB were assessed following EPPO PP1/26 guideline prescriptions. An FHB index ((incidence*severity)/100) was calculated to rate the efficacy of compound I. The trial was also harvested to determine a yield of the crop (tonnes per hectare, t/ha) as compared to untreated controls. Results are given in Table 4.

Field Assessment of Blumeria Graminis f. Sp. Tritici (ERYSGT) in Durum Wheat:

A fungicidal treatment containing Compound I was assessed against powdery mildew of wheat (ERYGST) in three separate field trials. In each trial, all Compound I treatments (EC or SC formulation) were applied in a tank mix with either Plurafac LF 1300 EC (1:4 ratio with Compound I) or Agnique BP420 EW (1:5.2 ratio with Compound I) plus Agnique FOH TDA-9 (300 g/L solution) at 0.33% v/v as adjuvants. In the first trial, a fungicidal treatment containing Compound I was applied at B31-46 (early curative, after first appearance of disease in the field) growth stage of Durum wheat (TRZDU, Ettore variety) at a rate of 25, 50, 75, 100 and 150 g ai/ha under natural infection of powdery mildew plus artificial enrichment. The treatment was part of an experimental trial designed as a randomized complete block with four replications and a plot of approximately 3×3 m. Treatments were applied at water volume of 250 L/ha, using a backpack plot sprayer (BKPCENG, FLATFAN XR11003 TEEJET nozzle) and pressurized at 3 bar. Disease severity (% plot infection) was assessed on 25 leaves per plot (L1-L4) at 0, 21, 28 and 35 DAAA (days after application A).

In the second trial, a fungicidal treatment containing Compound I was applied at B31-46 (early curative, after first appearance of disease in the field) growth stage of Durum wheat (TRZDU, Ettore variety) at a rate of 25, 50, 75, 100 and 150 g ai/ha under natural infection of powdery mildew plus artificial enrichment. The treatment was part of an experimental trial designed as a randomized complete block with four replications and a plot of approximately 2×5 m. Treatments were applied at water volume of 250 L/ha, using a backpack plot sprayer (BKPCENG, FLATFANA AIX110015 TEEJET nozzle) and pressurized at 300 KPa. Disease severity (% plot infection) was assessed on 20 leaves per plot (L1-L4) at 0, 19, 32 and 43 DAAA.

In the final trial, a fungicidal treatment containing Compound I was applied at B31-46 (early curative, after first appearance of disease in the field) growth stage of Durum wheat (TRZDU, Ettore variety) at a rate of 25, 50, 75, 100 and 150 g ai/ha under natural infection of powdery mildew. The treatment was part of an experimental trial designed as a randomized complete block with four replications and a plot of approximately 2×3 m. Treatments were applied at water volume of 200 L/ha, using a backpack plot sprayer (BKPCAIR). Disease severity (% plot infection) was assessed at 14, 28 and 38 DAAA.

Disease severity (percentage of visual diseased foliage on whole plot or leaves) in all three field trials was recorded following EPPO PP1/26 guideline prescriptions. Area under the disease progress curve (AUDPC) was calculated for each plot in each of the three trials using the sets of recorded severity data. Relative AUDPC (% control based on AUDPC) was calculated as percent of the nontreated control. Final results for the control of powdery mildew on wheat by compound I (Table 5) are reported as an average of the relative AUDPC calculated over all three field trials.

In each case of Table 1-4 the rating scale of percent control based on AUDPC is as follows:

| % Control | Rating |
|---|---|
| 76-100 | A |
| 51-75 | B |
| 26-50 | C |
| 1-25 | D |
| Not tested | E |

TABLE 1
Efficacy of Compound I against Brown Rust of
Wheat (PUCCRT, Puccinia recondita) in
Curative Tests with or without Adjuvant.^{a}

| Rate | | Test A^{d} | Test B^{e} |
|---|---|---|---|
| (g ai/ha)^{b} | Adjuvant^{c} | % Control | % Control |
| 50 | N | A | A |
| 100 | N | A | A |
| 25 | Y | A | B |
| 50 | Y | A | A |
| 100 | Y | A | A |
| 150 | Y | A | A |

^{a}Percent control based on Area Under Disease Progression Curve (AUDPC)
^{b}Grams of active ingredient per hectare
^{c}Agnique BP-420 (50% w/w at 0.3% v/v)
^{d}Test A: Early curative
^{e}Test B: Late curative

TABLE 2
Efficacy of Compound I against Stripe Rust of Wheat (PUCCST,
Puccinia striiformis) in Curative Trials.^{a}

| RATE | Curative Trials |
|---|---|
| (g ai/ha) | (% Control) |
| 50 | B |
| 100 | B |
| 150 | B |

^{a}Percent control based on Area Under Disease Progression Curve (AUDPC) over three separate trials.

TABLE 3
Efficacy of Compound I against Glume Blotch of Wheat
(LEPTNO, Parastagonospora nodorum).^{a}

| RATE | TRIAL | | |
|---|---|---|---|
| g ai/ha | Adjuvant^{b} | 3 DP^{c} | 2 DC^{d} |
| 50 | N | C | C |
| 25 | Y | C | C |
| 50 | Y | C | C |
| 100 | Y | B | B |
| 150 | Y | B | B |

^{a}Percent control based on Area Under Disease Progression Curve (AUDPC)
^{b}Agnique BP-420 (50% w/w at 0.3% v/v)
^{c}3 Day protectant
^{d}2 Day curative

TABLE 4
Efficacy and Yield Results of Compound I against
Fusarium Head Blight (FHB) Disease in Wheat.

| TEST | Percent Control^{a} | Yield^{b} |
|---|---|---|
| Untreated | D | 6.0 |
| Compound I | B | 8.4 |
| 100 g ai/ha | | |

^{a}Control was calculated with FHB index using incidence and %infection.
^{b}Results in tonnes/hectare (t/ha).

TABLE 5
Efficacy of Compound I against Powdery Mildew of Wheat
(ERYSGT, Blumeria graminis f. sp. tritici).^{a}

| Rate | | | |
|---|---|---|---|
| (g ai/ha)^{b} | Formulation | Adjuvant | % Control |
| 150 | EC | X^{c} | A |
| 150 | SC | Y^{d} | A |
| 100 | EC | X | A |
| 100 | SC | Y | A |
| 75 | EC | X | A |
| 50 | EC | X | B |
| 75 | SC | Y | B |
| 25 | EC | X | B |
| 50 | SC | Y | B |
| 25 | SC | Y | B |

^{a}Percent control based on Area Under Disease Progression Curve (AUDPC) over 3 trials
^{b}Grams of active ingredient per hectare
^{c}Adjuvant X: Plurafac LF 1300 EC (1:4 ratio with Compound I)
^{d}Adjuvant Y: Agnique BP420 EW (1:5.2 ratio with Compound I) with Agnique FOH TDA-9 (300 g/L solution) at 0.33% v/v

What is claimed is:

1. A method of controlling fungal diseases in a wheat plant that is at risk of being diseased comprising contacting one of the plant and an area adjacent to the plant with a composition including compound I.

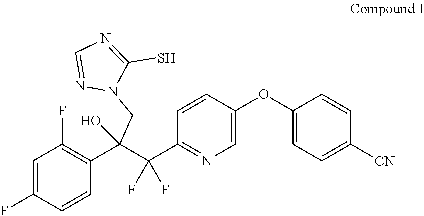 [SMILES: N#Cc1ccc(Oc2ccc(C(F)(F)C(O)(Cn3ncnc3S)c3ccc(F)cc3F)nc2)cc1]

2. The method of claim 1 wherein the composition is

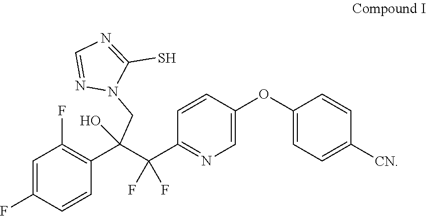 [SMILES: N#Cc1ccc(Oc2ccc(C(F)(F)C(O)(Cn3ncnc3S)c3ccc(F)cc3F)nc2)cc1]

3. The method of claim 1, wherein the composition further includes at least one of one additional agriculturally active ingredient selected from the group consisting of: insecticide, an herbicide, and a fungicide.

4. The method of claim 1, wherein the fungal pathogen is selected from the group consisting of the causal agents of wheat brown rust (Puccinia recondita), stripe rust of wheat (Puccinia striiformis), wheat glume blotch (Parastagonospora nodorum), Fusarium head blight (FHB), (Fusarium graminearum, Fusarium culmorum, Fusarium avenacium and Fusarium poae), and powdery mildew of wheat (Blumeria graminis f. sp. tritici).

5. The method of claim 2, wherein the composition further includes at least one of one additional agriculturally active ingredient selected from the group consisting of: insecticide, an herbicide, and a fungicide.

6. The method of claim 2, wherein the fungal pathogen is selected from the group consisting of the causal agents of wheat brown rust (Puccinia recondita), stripe rust of wheat (Puccinia striiformis), wheat glume blotch (Parastagonospora nodorum), Fusarium head blight (FHB), (Fusarium graminearum, Fusarium culmorum, Fusarium avenacium and Fusarium poae), and powdery mildew of wheat (Blumeria graminis f. sp. tritici).
